(19) United States
(12) Patent Application Publication
(10) Pub. No.: US 2010/0230939 A1
(43) Pub. Date: Sep. 16, 2010

(54) Air Bag Chute Seal

(75) Inventors: Nicholas A. Mazzocchi, Canton, MI (US); Derek L. Roberts, Clarkston, MI (US); Brian C. Slane, Flat Rock, MI (US); John M. Weiher, Toledo, OH (US); Jasen R. Joseph, Warren, MI (US)

Correspondence Address: AUTOMOTIVE COMPONENTS HOLDINGS LLC;C/O MACMILLAN, SOBANSKI & TODD, LLC, ONE MARITIME PLAZA, FIFTH FLOOR, 720 WATER STREET, TOLEDO, OH, 43604-1853, US

(73) Assignee: AUTOMOTIVE COMPONENTS HOLDINGS, LLC, Dearborn, MI (US)

(21) Appl. No.: 12/404,410

(22) Filed: Mar. 16, 2009

(51) Int. Cl. B60R 21/205

(52) U.S. Cl. 280/732

(57) ABSTRACT

An integrated air bag chute structure that provides sealing of an air bag aperture in an instrument panel substrate during a foam-in-place process. The structure provides an extended flange with flexible tapered edges that surround the aperture. The tapered edges are compressed against the upper surface of the substrate to seal and surround the substrate aperture when the chute structure is inserted into and retained in the substrate aperture. The air bag chute structure further defines a door support panel with pre-weakened molded edges and a hinge which are all integrally connected to the structure and flange without gaps that would allow for leakage during the foam-in-place process.

### CROSS-REFERENCE TO RELATED APPLICATIONS

This application is related to the commonly assigned application filed contemporaneously herewith and entitled: INTERLOCKING ONE PIECE MOLDED PASSENGER AIR BAG CHUTE, U.S. Ser. No. (81,187,069(19030)).

### BACKGROUND OF THE INVENTION

1. Field of the Invention

This invention relates to the field of air bag deployment systems for an automotive vehicle and more particularly to the area of an air bag chute structure.

2. Description of the Related Art

In this technology field, there have been several attempts to provide a passenger air bag chute attached to a vehicle interior panel. In cases where there is a foam-in-place process used to provide the foam layer between the air bag deployment door of a chute that is mounted on the instrument panel substrate and the outer skin layer, a seal element is typically employed to prevent leakage of the foam material during the process.

U.S. Pat. No. 6,644,685 describes an air bag chute with a base reinforcement portion that surrounds a deployment door. When foam is injected as a liquid between the instrument panel substrate and the outer skin, a gasket or adhesive tape is described as being used to prevent leakage of the liquid foam from gaps formed between the reinforcement portion and the substrate.

U.S. Pat. No. 6,709,007 describes an embodiment of an air bag deployment chute attached to the substrate of an instrument panel with bolts. A layer of masking tape or a die cut polymer with an adhesive on each surface is applied between the reinforcing ring and the instrument panel substrate to prevent the foam from penetrating between those elements.

U.S. Pat. Nos. 6,716,519 and 7,237,797 also show the use of sealing layers such as masking tape to prevent foam migration through mating surfaces on the instrument panel.

### SUMMARY OF THE INVENTION

The inventive concept is directed to an improved method and apparatus, for use in an air bag deployment system that includes an air bag deployment chute formed to have an encircling flange member that seals itself against the upper surface of an instrument panel substrate to prevent foam migration during the foam-in-place injection process.

The inventive concept includes an integrated air bag deployment chute structure with a support base for attachment to an opening in a vehicle interior substrate. The support base is configured with a flange that surrounds a door support panel and overlays the opening in the vehicle interior substrate when inserted therein. The flange has outer edges that are flexible and tapered to lie flat against the substrate surface to both seal the interface and minimize interference to the flow of foam during the foam-in-place injection process.

A rectangular air bag chute tube extends downward from the support base. The chute side walls form a skirt that will ultimately surround a separate air bag container and define the path for deployment of the air bag from the air bag container. The door support panel is generally co-planar with the support base flange and has defined door edges formed on three sides by pre-weakened molding or scoring. The door support edges remain attached to the support base prior to deployment of the air bag. A door support hinge element is formed to extend along one side of the defined door. The entire upper surface of the air bag deployment chute that includes the door support panel and the flange is continuously closed without gaps or openings so that there is no potential path for foam leakage during the foam-in-place injection process.

Therefore, it is an object of the inventive concept to provide an improved air bag deployment chute that has a seam that is self sealing with respect to the underlying instrument panel substrate to prevent leakage at the seam during a foam-in-place process.

It is another object of the inventive concept to provide an improved air bag chute that is an integrated structure with a surrounding flange having a tapered edge that seals against the upper surface of the instrument panel to which the air bag chute is mounted prior to performing a foam-in-place process.

It is a further object of the inventive concept to provide an air bag chute structure used in an air bag deployment system of an automotive vehicle wherein the structure is configured to be installed in an aperture of an instrument panel substrate; the structure contains an upper portion with a flange having flexible tapered edges surrounding the structure; the tapered edges are formed of a flexible material and oriented to engage the upper surface of the substrate surrounding the aperture when the structure is inserted into the aperture.

It is a still further object of the inventive concept to provide a method of sealing an air bag deployment chute structure to the upper surface of a substrate of an instrument panel prior to subjecting the structure and substrate to a foam-in-place process by the steps of providing the chute structure with a flange that extends around a defined deployment door support panel sufficiently to exceed the dimensions of the aperture; providing the outer edges of the flange with tapered and flexible edges that are biased slightly downward to lie against the upper surface of the substrate; insert the air bag deployment chute structure into an aperture in the substrate so that the tapered edges engage the upper surface of the substrate and seal the upper surface from migration of foam during the foam-in-place process.

It is a still further object of the inventive concept to provide an air bag chute structure for use in an instrument panel air bag deployment system of an automotive vehicle, comprising: a generally planer deployment door support panel portion integrated in the structure and defined by a plurality of pre-weakened edges and a flexible hinge with an upper surface and a lower surface; a generally planar flange member portion with an upper surface and a lower surface extending from the area surrounding the door support panel; an air bag chute portion extending from an area adjacent the lower surfaces at a junction of the door panel and the flange for insertion into a corresponding aperture formed in the substrate of an instrument panel; and the flange member containing continuous outer tapered edges formed of flexible material biased slightly downwards to allow the lower surface thereof to conform to the upper surface of said substrate when said air bag chute is inserted into said aperture.

A more complete description of an embodiment of the inventive concept is presented below.

### BRIEF DESCRIPTION OF THE SEVERAL VIEWS OF THE DRAWINGS

FIG. 1 is a perspective view of the air bag chute structure of the present invention.

FIG. 2 plan view of a portion of the instrument panel of a vehicle in which an air bag chute structure is mounted.

FIG. 3 is a cross-sectional plan view of the air bag chute structure taken along lines 3-3 in FIG. 1.

### DETAILED DESCRIPTION OF THE INVENTION

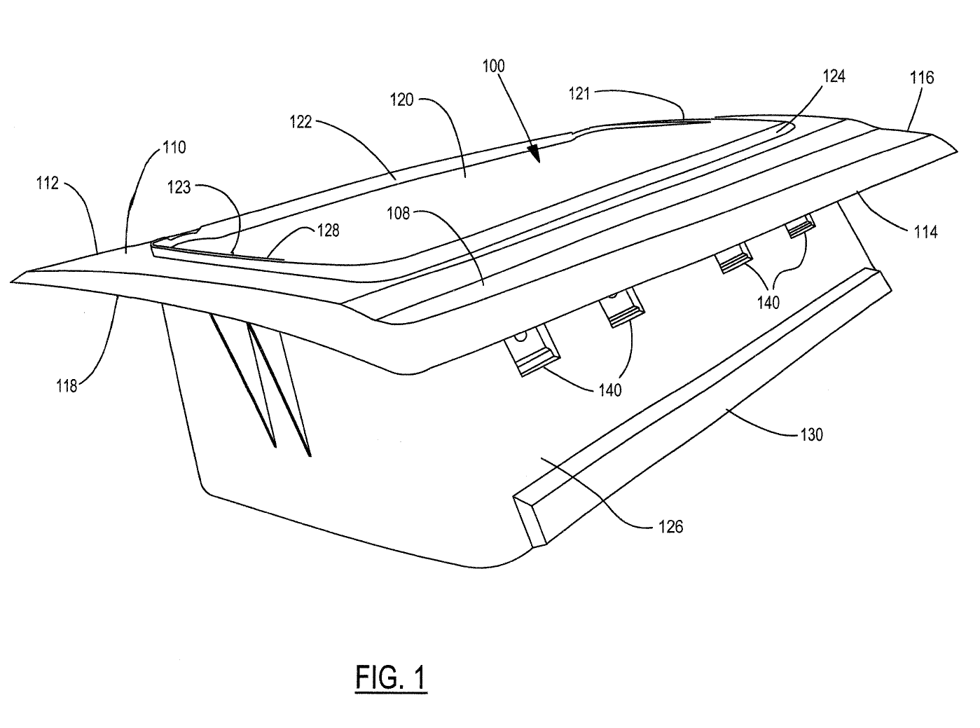

The perspective view of the air bag chute 100 of the present invention is shown in FIG. 1 with the forward or windshield side in the foreground and the rear or passenger side in the background. The air bag chute 100 is embodied as a unitary structure 110 that is molded of a plastic material preferably having some flexibility to prevent fracturing during air bag deployment in all expected temperatures of operation. The upper portion of the structure 110 includes a door support panel 120 that is defined by a pre-weakened seam 122 at the outermost (initially rupturing) edge and a pair of pre-weakened seams on side edges 121 and 123. A hinge 124 defines the fourth side of the door support panel 120.

When installed on the instrument panel of a passenger vehicle, the hinge is closest to the windshield of the vehicle and the initially rupturable seam 122 is located closest to the passenger seating position.

The air bag chute structure 100 is formed as a one piece molding of a flexible material such as Dexflex™ or other material that exhibits equivalent or superior ductility at very cold temperatures at least to −30° C. and good toughness at high temperatures at least to 90° C. Other materials such as TPO (Thermoplastic Olefin), TPE (Thermoplastic Elastomer or TEO (Thermoplastic Elastomer Olefin) could be substituted.

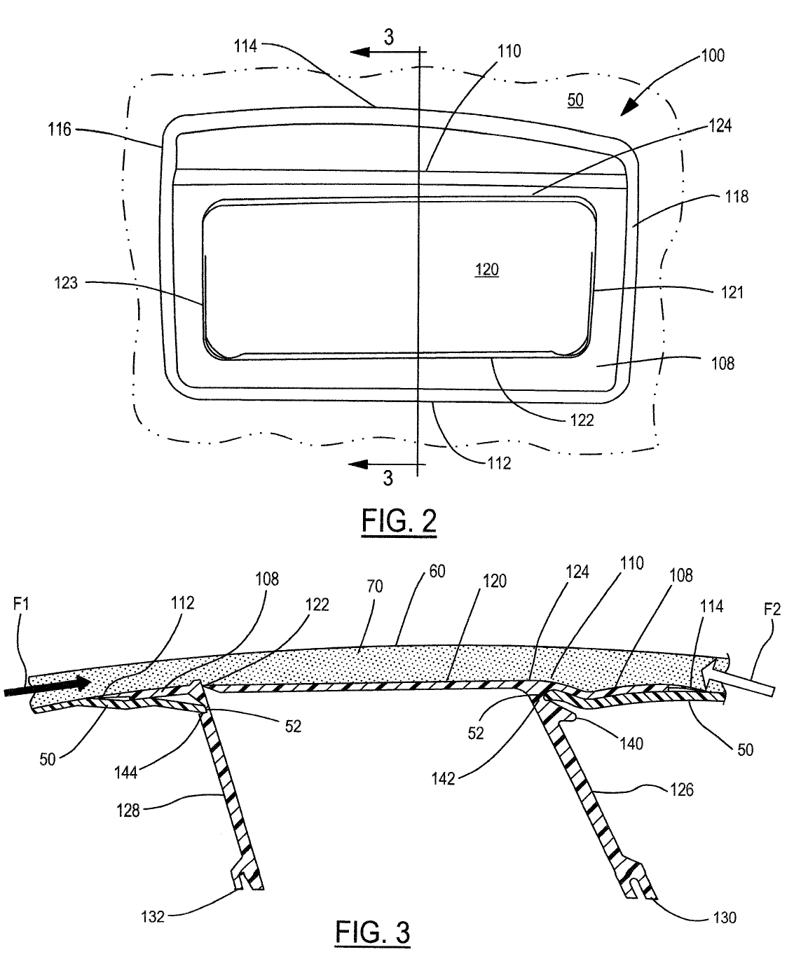

Door support panel 120 is surrounded by a mounting flange 108 that is generally rectangular in shape, but is shown in the embodiment in FIG. 2 as having an elongated extension on its upper right corner to accommodate a particular instrument panel surface. The portion of the air bag chute 100 that is key to the invention is the flexible and tapered edges 112, 114, 116 and 118 of mounting flange 108. The tapered edges are formed to be biased slightly downward so that when installed in the aperture of an instrument panel substrate 50, the flange will provide a compression seal with respect to the substrate surface. In this case the tapered edges are formed integrally with the flange 108 and the structure 110. However it is envisioned that in future embodiments, one might attach flexible tapered edges to the outer perimeter of flange 108 which could be formed of a different and more rigid material.

A plurality of windows 140 are located on opposing lower chute side walls 126 and 128 and reinforcement bars 130 and 132 located at the lowest edge of the chute walls 126 and 128 (FIG. 3). The windows 140 are provided to interlock with hooks extending from the air bag container module (not shown) in a conventional manner.

In FIG. 2, the air bag chute 100 is shown mounted in the aperture of an instrument panel substrate 50 prior to being covered with the finished decorative and/or padded skin of the instrument panel. In this view the pre-weakened seams that form edges 121 and 123 are represented, as well as and the pre-weakened seam 122 that forms leading edge of door support panel 120.

In FIG. 3, a cross-sectional view of the air bag chute structure 110 is shown taken along section line 3-3 in FIG. 2 while mounted on instrument panel substrate 50. The drawing illustrates air bag 100 chute in its finished condition mounted on the instrument panel 50 and covered with a foam interlayer 70 and a “class A” outer skin 60. It should be noted that many choices of outer skin layers or laminations can be used that are both conventional and yet to be invented. The actual materials used for the outer skin are not pertinent to the present invention except for the property of containing the initially injected foam in its liquid form, and later the foam flow back as it approaches its solid form during the foam-in-place process described above.

The air bag chute structure 110 is inserted into the aperture 52 defined in the instrument panel substrate 50. A guide tab 140 is located under flange 108 and extends from the outside of side wall 126 towards the tapered outer edge 114. A slot 142 is formed between the guide tab 140 and the underside of flange 108 below and in the vicinity of hinge 124. Slot 142 is only slightly larger than the thickness of the substrate 50, at that location, and allows the chute structure to positively engage the edge of aperture 52. When installed, the tapered edge 114 of flange 108 sealingly engages the upper surface of substrate 50.

At the rear side of the air bag chute structure 110, a notch 144 is formed in the outside of sidewall 128 below and in the vicinity of the leading edge 122 of the support door 120. Notch 144 engages the edge of aperture 52 and locks the air bag chute structure 110 in place prior to performing the foam-in-place process. The tapered edge 112 of flange 108 sealingly engages the upper surface of substrate 50. Although not shown, the other tapered edges 116 and 118 of flange 108 also sealingly engage the upper surface of substrate 50. When installed, as shown in FIG. 3, the tapered edges 112, 114, 116, 118 provide a complete seal of the opening 52 in substrate 50 without the requirement for masking tape or other add-on sealers.

During the foam-in-place-process, liquid foam is injected in the direction of the arrow F₁ between the substrate surface 50 and the skin 60 to partially fill the void between them. The injection volume over time provides a predictable back flow of foam as it solidifies in the direction of arrow F₂ The foam 70 reaches its full volume in the void as allowed by the fixtures holding the outer skin 60 with respect to the instrument panel substrate 50. When the liquid and solidifying foam passes over the air bag structure 110 and in particular the flange 108 and door support panel 120, there is no leakage into the air bag chute since it presents a completely closed surface. The tapered edges provide sealing with respect to the upper surface of the substrate 50 due to the edges being held in a compression state against that surface. This prevents the initially injected liquid foam from migrating below the seals. As the pressure increases from the liquid foam itself due to its expansion into a solid form, that pressure applies additional forces against the upper surface of the flange 108 and the tapered edges to further ensure that no leakage occurs. Complete integrity is therefore provided to prevent leaks of foam below the substrate and into the air bag storage area.

It can be seen from the drawings and accompanying explanation, that the present inventive concept is a unique improvement over conventional air bag deployment support structures and methods of installation. And while the embodiment shown here is a preferred embodiment, it shall not be considered to be a restriction on the scope of the claims set forth below.

We claim:

1. An air bag chute structure used in an air bag deployment system of an automotive vehicle:
said structure configured to be installed in an aperture of an instrument panel substrate;
said structure containing an upper portion that contains a flange with flexible tapered edges surrounding said structure;
said tapered edges being formed of a flexible material and oriented to engage the upper surface of said substrate surrounding said aperture when said structure is inserted into said aperture.

2. An air bag chute structure as in claim 1, wherein said structure further contains an air bag chute portion defined by side walls which extend downward from said upper portion;
said side walls contain means for engaging with the edges of said aperture to hold said structure to said substrate when said structure is inserted therein.

3. An air bag chute structure as in claim 1, wherein said upper portion of said structure is continuous and without apertures, gaps and holes that are open to the lower portion thereof.

4. An air bag chute structure as in claim 1 wherein said tapered edges form a seal with respect to said upper surface of said substrate and prevent the migration of liquid foam into said aperture during a foam-in-place process.

5. An air bag chute structure as in claim 4, wherein said structure further contains an air bag chute portion defined by side walls which extend downward from said upper portion;
said side walls contain means for engaging with the edges of said aperture to hold said structure to said substrate when said structure is inserted therein.

6. An air bag chute structure as in claim 4, wherein said upper portion of said structure is continuous and without apertures, gaps and holes that are open to the lower portion thereof.

7. A method of sealing an air bag deployment chute structure to the upper surface of a substrate of an instrument panel prior to subjecting said structure and substrate to a foam-in-place process:
providing said chute structure with a flange that extends around a defined deployment door support panel sufficiently to exceed the dimensions of said aperture;
providing the outer edges of said flange with tapered and flexible edges that are biased slightly downward to lie against the upper surface of said substrate;
insert said air bag deployment chute structure into an aperture in said substrate so that said tapered edges engage the upper surface of said substrate and seal said upper surface from migration of foam during said foam-in-place process.

8. A method as in claim 7, wherein said step of providing said chute structure includes the step of forming said structure with a defined deployment door support panel and adjacent flange without apertures, gaps and holes that are open to the lower portion thereof.

9. A method as in claim 8, wherein said step of inserting said air bag deployment chute structure into an aperture includes the step of attaching said chute structure to said substrate to maintain said tapered edges in continuous engagement with the upper surface of said substrate and thereby sealing said upper surface to prevent migration of foam through said aperture during said foam-in-place process.

10. A method as in claim 7, wherein said step of inserting said air bag deployment chute structure into an aperture includes the step of attaching said chute structure to said substrate to maintain said tapered edges in continuous engagement with the upper surface of said substrate and thereby sealing said upper surface to prevent migration of foam through said aperture during said foam-in-place process.

11. An air bag chute structure for use in an instrument panel air bag deployment system of an automotive vehicle comprising:
a generally planer deployment door support panel portion integrated in said structure and defined by a plurality of pre-weakened edges and a flexible hinge with an upper surface and a lower surface;
a generally planar flange member portion with an upper surface and a lower surface extending from the area surrounding said door support panel;
an air bag chute portion extending from an area adjacent said lower surfaces at a junction of said door panel and said flange for insertion into a corresponding aperture formed in the substrate of an instrument panel; and
said flange member containing continuous outer tapered edges formed of flexible material biased slightly downwards to allow the lower surface thereof to conform to the upper surface of said substrate when said air bag chute is inserted into said aperture.

12. An air bag chute structure as in claim 11, wherein said door, flange, and chute portions are formed as an integral unit.

13. An air bag chute structure as in claim 12, wherein said integral unit is formed from a flexible thermoplastic material molding.

14. An air bag chute structure as in claim 11, wherein said door and flange portions are continuous and without apertures, gaps and holes that would allow any leakage from the upper surface to the lower surface thereof.

15. An air bag chute structure as in claim 14, wherein said tapered edges form a seal with respect to said upper surface of said substrate and prevent the migration of liquid foam into said aperture during a foam-in-place process.
